(19) United States
(12) Patent Application Publication
(10) Pub. No.: US 2026/0220814 A1
(43) Pub. Date: Jul. 30, 2026

(54) METHOD AND ARRANGEMENT FOR DETERMINING A POSE OF AN AERIAL VEHICLE

(71) Applicant: Spacemetric AB, Sollentuna (SE)

(72) Inventor: Daniel SABEL, Upplands Väsby (SE)

(21) Appl. No.: 19/105,421

(22) PCT Filed: Sep. 1, 2023
(86) PCT No.: PCT/SE2023/050867

§ 371 Date: Feb. 21, 2025

(30) Foreign Application Priority Data
Sep. 3, 2022 (SE) 2251016-8

(51) Int. Cl. G06T 7/73; B64D 47/08; G01S 17/86; G01S 17/89; G06T 7/33

(52) U.S. Cl. CPC G06T 7/74; B64D 47/08; G01S 17/86; G01S 17/89; G06T 7/337; G06T 2207/10016; G06T 2207/10032; G06T 2207/30188; G06T 2207/30252

(57) ABSTRACT

Method of determining a pose of an aerial vehicle is provided, where the pose is related to at least one of the aerial vehicle's location and the aerial vehicle's orientation. The method comprises: obtaining a reference point cloud; determining a vehicle point cloud representing vegetation structures of the environment related to the position of the aerial vehicle; comparing the vehicle point cloud with the reference point cloud to generate a mathematical transformation therebetween; and determining the pose of the aerial vehicle based on the mathematical transformation. Thus, the proposed method may both enable reliable and accurate navigation when access to GNSS fails, and support inertial navigation systems.

### TECHNICAL FIELD

This disclosure relates to control of vehicles, especially to determination of the position and attitude of aerial vehicles.

### BACKGROUND

For aerial vehicles, e.g. aeroplanes, it is important to navigate appropriately, both for security and economic reasons. An aerial vehicle which is flying along a route between two destinations should e.g. avoid collisions with other aerial vehicles or environmental objects.

To optimise the routes it is also of importance to be aware of the aerial vehicles' current locations.

Traditionally, aeroplanes have been guided by operators from control towers, where the operators identify the aeroplanes on radar monitors and give instructions to the aeroplanes' pilots. The pilots themselves are in general not capable of visually identifying obstacles or navigate appropriately, and are dependent on such passive guidance for navigating securely and with precision.

Later, solutions have been proposed where the aeroplanes send their positions (e.g. GPS coordinates, Global Positioning System) not only to the control towers, but also to other aeroplanes in an appropriate vicinity. The pilots themselves will then be able to identify other vehicles' current positions. One example of such an active navigation system for navigating aeroplanes is STDMA (Self-organizing Time Division Multiple Access), which today is a world standard.

Unmanned Aerial Vehicles (UAVs) can vary in size from a few hundred grams to that of conventional fixed or rotary wing aircrafts. While originally developed for military purposes such as reconnaissance or aerial attacks, UAVs are today increasingly being used in the civilian and public domains. The advantages of UAVs include cost effectiveness, ease of deployment and possibilities for automated operations. Applications include real-time monitoring of road traffic, environmental remote sensing, search and rescue operations, delivery of medical supplies in hard-to-reach areas, security and surveillance, precision agriculture, and civil infrastructure inspections.

Increasing degrees of automation and autonomy in UAVs are expected to provide immense advantages, especially in support of public safety, search and rescue operations, and disaster management. Automatically or autonomously navigating UAVs require reliable positioning systems in order to guarantee flight safety, in particular if the airspace is shared with manned aerial vehicles.

Global Navigation Satellite Systems (GNSSs), e.g. GPS and Galilei, are cornerstones of today's aerial navigation. However, there are situations when positioning with GNSS can be rendered unusable or unreliable. The cause of this can be instrument failure, signal obstruction, multipath issues from mountains or tall buildings, and unintentional radio frequency interference as well as malicious jamming or spoofing. Such events can quickly render a UAV uncapable of navigating safely and thus compromises flight safety. The importance of being able to navigate without GNSS has been highlighted, e.g., by the U.S. Army as a reaction to increased concerns of jamming and spoofing of GPS signals targeted at their unmanned aircraft systems.

The patent publication WO2018/145291, A1, discloses a prior art method for real-time location tracking that deviates from the inventive concept to be defined below.

There is a need to make aerial navigation further more secure and efficient.

### SUMMARY

It would be desirable to improve performance in navigation of aerial vehicles. It is an object of this disclosure to address at least one of the issues outlined above.

Further there is an object to devise a method that facilitates determination of aerial vehicles' poses based on measurements of vegetation structures. These objects may be met by an arrangement according to the attached independent claims.

According to a first aspect, a method of determining a pose of an aerial vehicle is provided, where the pose is related to at least one of the aerial vehicle's location and the aerial vehicle's orientation. The method comprises: obtaining a reference point cloud representing three-dimensional vegetation structures; determining a vehicle point cloud representing three-dimensional vegetation structures of the environment related to the position of the aerial vehicle; comparing the vehicle point cloud with the reference point cloud to generate a mathematical transformation therebetween; and determining the pose of the aerial vehicle based on the mathematical transformation.

Comparison of the vehicle point cloud with the reference point cloud may comprise: calculating a mathematical transform that aligns the vehicle point cloud and the reference point cloud, based on identified point correspondences, where the point correspondences were identified based on, either comparison of 3D features in the vehicle point cloud and the reference point cloud; or through direct comparison between the vehicle point cloud and the reference point cloud.

Determination of the pose may comprise determination of at least one parameter of the aerial vehicle from a set of: x-coordinate, y-coordinate, z-coordinate, roll (φ), pitch (θ) and yaw (ψ), the pose being defined by at least one of the determined parameters.

Determination of the vehicle point cloud may comprise acquiring sensor data by means of an instrument arranged at the aerial vehicle, wherein the instrument is a passive instrument, preferably an image capturing device, or an active instrument, such as a laser scanner.

According to a second aspect, a pose determination module is provided, that comprises a communication unit, a processing unit, and optionally a memory unit. The pose determination module is configured to perform the methods according to above defined aspects. Aerial vehicles may be equipped with an Inertial Navigation System (INS) that allows navigating sufficiently accurately without the use of GNSS or other external references for some limited period of time. If the aerial vehicle enters a GNSS-denied environment, it can for some period of time still compute its position sufficiently accurately with the use of the INS. However, the uncertainty in the INS-based position will increase over time, as measurement errors in the INS accumulates. With the use of the proposed method, i.e. of making use of vegetation structures, the vehicle's position can be estimated and the bias in the INS-based position estimate be corrected.

Thus, the proposed method may both enable reliable and accurate navigation when access to GNSS fails, and support inertial navigation systems.

### BRIEF DESCRIPTION OF DRAWINGS

The solution will now be described in more detail by means of exemplifying embodiments and with reference to the accompanying drawings, in which:

FIG. 1 is a schematic illustration of coordinate reference systems, according to possible embodiments.

FIG. 2 is a schematic flowchart of a method of determining a vehicle pose, according to possible embodiments.

FIG. 3 is a schematic illustration of principles for determining a vehicle pose, according to possible embodiments.

FIG. 4 is a schematic illustration of principles for determining a vehicle pose, according to possible embodiments.

FIG. 5 is a schematic illustration of a vehicle pose determination unit, according to possible embodiments.

FIG. 6 is a schematic illustration of an aerial vehicle, according to possible embodiments.

### DETAILED DESCRIPTION

An alternative to GNSS for map-relative localization is vision-based localization, whereby data from a sensor mounted on the aerial vehicle is compared with a reference model of the environment. The sensor is often a camera, but can also be a laser scanner, a radar altimeter, or some other type of sensor. The reference model may consist of geocoded (sometimes referred to as georeferenced) satellite or aerial images, or 3D models, which are stored onboard the aerial vehicle.

At its core, vision-based localization is a sensor pose estimation problem, where the objective is to estimate the position, i.e., the three spatial coordinates of the sensor, as well as the orientation, i.e., the three angles of rotation relative to some frame of reference. With knowledge of how the sensor is mounted or situated in relation to the aerial vehicle, it is trivial to compute the vehicle pose from the sensor pose. A main challenge with vision-based localization is the accurate registration of the aerial vehicle's sensor data with the reference model.

Vision-based localization is useful in urban areas where GNSS may not provide sufficient accuracy or where GNSS may be unreliable, e.g., due to signal obstruction or multipath issues. Vision-based localization is also useful in non-urban areas, e.g., when there is a risk for jamming or spoofing of the GNSS signals. The use of UAVs in non-urban and natural environments is beneficial for applications such as reconnaissance, search and rescue operations and delivery of medical supplies to remote locations. Urban environments typically contain an abundance of landmarks that are distinct and stable over time, such as buildings and road junctions, which are suitable for matching against a reference model. The same abundance of landmarks is typically not found in natural environments such as forested landscapes or open terrain.

Furthermore, accurate registration against a reference model in such natural environments is made complicated by variations such as direction and length of shadows, leaf on/leaf off conditions, the presence or absence of snow cover, as well as natural growth and decay. In case of low-altitude flights, differences in observation perspective between the vehicle's sensor data and the reference model adds to the complexity of correctly registering sensor data with the reference data. Low flight altitude also reduces the area on the ground observable from the vehicle, which reduces the probability of observing distinct features or landmarks. Therefore, vision-based localization methods relying on information extracted from an image captured by an onboard camera, such as color, texture or 2D features, is often for low-altitude navigation over vegetated terrain.

Instead of relying on image information, such as color, texture or 2D features, the proposed method for vision-based localization exploits the three-dimensional structures in the vegetation. The use of three-dimensional structures alleviates the problems of registering the vehicle's sensor data with the reference model over vegetated areas, and provides benefits over methods relying on information directly available in an image.

In a general concept, a method of determining a pose of an aerial vehicle, where the pose is related to at least one of the aerial vehicle's location and the aerial vehicle's orientation comprises: obtaining a reference point cloud; determining a vehicle point cloud representing vegetation structures of the environment related to the position of the aerial vehicle. The method further comprises comparing the vehicle point cloud with the reference point cloud to generate a mathematical transformation therebetween; and determining the pose of the aerial vehicle based on the generated mathematical transformation. By way of an example, comparing the vehicle point cloud with the reference point cloud comprises calculating the mathematical transform that aligns the vehicle point cloud with the reference pint cloud, based on identified point correspondences, where the point correspondences were based on a comparison of 3D features in the vehicle point cloud and the reference point cloud, or direct comparison between the vehicle point cloud and the reference point cloud.

Further to the general concept, a pose determination module for determining a pose of an aerial vehicle comprises a communication unit configured to obtain a reference point cloud, and a determination unit. The determination unit is configured to: determine a vehicle point cloud representing vegetation structures of the environment related to the position of the aerial vehicle; compare the vehicle point cloud with the reference point cloud to generate a mathematical transform therebetween; and determine the pose of the aerial vehicle based on the mathematical transform. By way of an example, the determination unit is configured to compare the vehicle point cloud with the reference point cloud according to the above defined example method.

The term “pose” will be used to denote any combination of position parameters and orientation parameters. For instance, position parameters may be the coordinates x, y, z in the world CRS, or the orientation angels pitch (θ), roll (φ), and yaw (ψ).

The term “vegetation structure” will be used herein for referring to the geometric shape or geometric distribution of individual vegetation objects, or of groups of vegetation objects.

“Sensor data” denotes herein a dataset captured by an instrument onboard the aerial vehicle. For instance, an image acquired by a camera, or measurements obtained by a radar receiver or laser scanner.

“Point cloud” here denotes a discrete set of data points in a 3D coordinate system and thus can represent any three-dimensional shape or object, or more precisely any set of points sampled on a shape or object. Each data point in the point cloud is associated with its own set of cartesian coordinates (X, Y and Z), and possible with other attributes as well, such as color. In the current context, point clouds are used to represent vegetation structure.

“3D feature” here denotes any data representation (e.g. a vector of numbers, sometimes referred to as a histogram or a signature) that encodes information, e.g. geometric shape or point distribution, which is based on analysis of data points in a point cloud. 3D features are used here to encode the shape as well as relative arrangement of vegetation such as trees, bushes, or thickets, e.g. tree crowns, trunks, or logs, based on analysis of point cloud data. Correspondences between 3D features in sensor data and reference data are used in the proposed registration method.

“3D descriptors” are mathematical algorithms used to compute 3D features based on point cloud data. A 3D descriptor commonly encodes the 3D features by analysis of point cloud data with respect to some Local Coordinate Reference Frame (LCRF). As the orientation of the point cloud generated onboard from sensor data may be unknown, such an LCRF must be estimated through analysis of the point cloud data itself. This is a critical component of the 3D descriptor, as misalignment of the LCRFs between the sensor data and the reference data significantly impairs the coherence of the 3D features computed from those data, and thus significantly impair the process of finding reliable feature correspondences between the sensor data and the reference data. For this reason, the LCRF estimation algorithm must be resilient to variations in, e.g., point cloud density and noise.

“Reference point cloud” is point cloud data which contain world Coordinate Reference System (CRS) coordinates for each of its points and that is used by the method as a model of the environment.

It is assumed that the aerial vehicle is equipped with an Inertial Navigation System (INS) that allows navigating sufficiently accurately without the use of GNSS or other external references for some limited period of time. If the aerial vehicle enters a GNSS-denied environment, it can for some period of time still compute its position sufficiently accurately with the use of the INS. However, the uncertainty in the INS-based position will increase over time, as measurement errors in the INS accumulates. With the use of the proposed method, the vehicle's position can be estimated and the bias in the INS-based position estimate be corrected. As the position and orientation drift rates of the INS are known a priori, is it possible to estimate the vehicle's pose uncertainty, which in turn allows to compute the extent in the reference point cloud that should be considered by our proposed method. Furthermore, the information provided by the INS about the vehicle's orientation can be used to compute more coherent and reliable 3D features by constraining the 3D descriptor's computation of the Local Coordinate Reference Frame (LCRF).

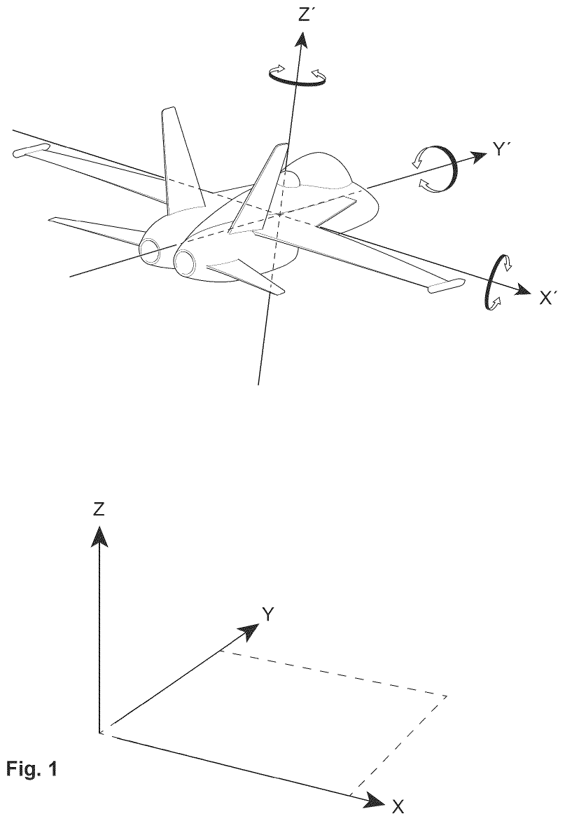

With reference to FIG. 1, which is a schematic illustration, two types of coordinate system will now be described.

A world (CRS with axes X, Y and Z, is used to define a position above the Earth's surface. The world CRS can be defined with respect to any map projection, such as a Universal Transverse Mercator (UTM) map projection, and any reference surface, such as the 1996 Earth Gravitational Model (EGM96) geoid. A horizontal coordinate pair x, y, together with an elevation z above the reference surface, defines a three-dimensional, 3D, position in the environment. A vehicle CRS (X′, Y′, Z′), which is fixed both in origin and orientation relative to the body of the vehicle, is used to define the vehicle's position and orientation relative to the world CRS. The orientation of the vehicle in the vehicle CRS is defined by the angles of rotation of the vehicle around the vehicle CRS axes X′, Y′ and Z′, denoted, respectively, pitch (θ), roll (φ), and yaw (ψ).

The position and orientation of the aerial vehicle in the world CRS is defined by a rigid-body transformation, i.e. translation and rotation, of the vehicle's pose expressed in the vehicle CRS.

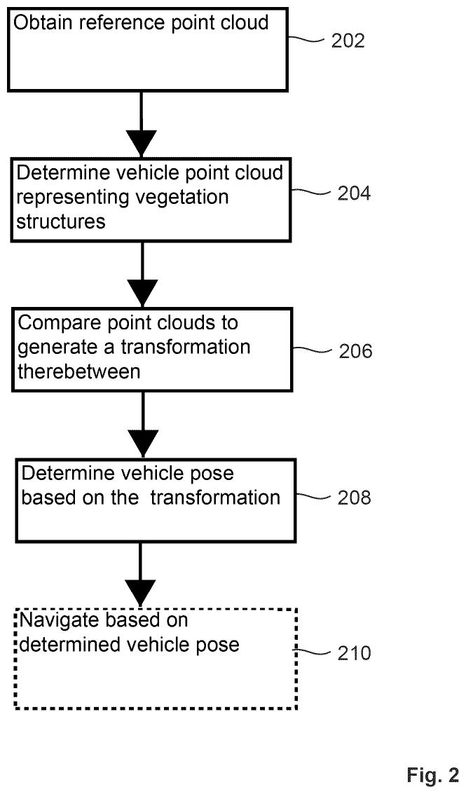

With reference to FIG. 2, which is a schematic flow chart, a method for determining a pose of an aerial vehicle will now be described in accordance with an exemplifying embodiment.

In an initial action 202, a reference point cloud is obtained. The reference point cloud comprises a 3D model of the environment in which the aerial vehicle is expected to navigate. Each point in the reference point cloud contains the point's coordinates in a world CRS. Such reference point clouds could be provided from appropriate sources, e.g. commercial or public databases. The obtained reference point cloud may be stored in memories onboard the aerial vehicle to be accessed when the aerial vehicle's pose shall be determined. Typically, the reference point cloud is stored in a memory onboard the aerial vehicle prior to its flight, to facilitate reliable data access. However, the inventive concept is not limited to storing the reference point cloud data onboard the vehicle prior its flight. Instead, the reference data could be obtained by continuously receiving data points during a flight. In addition to the reference point cloud, the 3D model may also contain 3D features computed from the reference point cloud. Computing 3D features from the reference point cloud prior to flight reduces the computational load onboard the aerial vehicle during flight.

In another action 204, a vehicle point cloud representing vegetation structures (and possibly also complemented by structures of other types), is determined by acquiring sensor data with an instrument arranged at the aerial vehicle and processing the sensor data to generate the vehicle point cloud based on the acquired sensor data. As the instrument is arranged onboard of the aerial vehicle, the acquired sensor data is related to the position of the aerial vehicle. In this embodiment, the instrument is a passive instrument, e.g. an appropriate type of camera, that is arranged at the aerial vehicle and is pointing towards to ground. The sensor data consist of two or more overlapping images captured by the camera. Processing these overlapping images with the use of motion stereo-matching results in the vehicle point cloud. Alternatively, the aerial vehicle may be equipped with further cameras that simultaneously acquire image pairs to be stereo-matched.

In an alternative embodiment, the vehicle point cloud is determined with the use of a laser scanner, i.e. an active instrument, that emits pulses of light and records their reflections for processing into the vehicle point cloud. The described concept may be applied for different types of passive and active instruments, e.g. photographic cameras, a stereo camera configuration, infrared (IR) cameras, laser scanning devices, radar devices, etc.

In a subsequent action 206, the vehicle point cloud is geocoded (or georeferenced) through a process called point cloud registration. First, the vehicle point is compared with a reference point cloud to identify points in the two point clouds that represent approximately the same position in the world. Pairs of corresponding points in the two point clouds are termed “point correspondences”. Such correspondences can be found either by comparing 3D features computed from the points clouds or through direct comparison of the point clouds. Typically, the calculations of the point correspondences involve some iterative processing method for removal of false point correspondences, like Random Sample Consensus (RANSAC), without being limited thereto. The point correspondences are used to compute a mathematical transformation that aims at aligning the vehicle point cloud with the reference point cloud. A common approach in point cloud registration is to perform a coarse geocoding by comparing 3D features, followed by fine geocoding by direct comparison of the point clouds. The resulting mathematical transform may consist of translation, rotation, and scale (7 parameters) or a subset thereof, depending on which parameters that are unknown. For instance, if the orientation and scale of the vehicle point cloud is known, the problem can be constrained to only estimate translation (3 parameters). The reference data can potentially cover very large geographical areas. To make the comparison with the vehicle point cloud computationally efficient, it is therefore necessary the constrain the search space in the reference data. The location and extent of the search space is based on the last known position of the aerial vehicle together with an estimation of the uncertainty in the current position.

In a following action 208, parameters of the aerial vehicle's pose are determined. The full pose parameters are coordinates (x, y, z) of the aerial vehicle's position in the world CRS and the angles pitch (θ), roll (φ), and yaw (ψ). These pose parameters are calculated based on the geocoded (or georeferenced) vehicle point cloud and its relation to the sensor data that were used to generate the vehicle point cloud. The inventive concept is not limited to calculate all six parameters x, y, z, θ, φ, ψ. Instead, any suitable combination of pose parameters and other measurements may be applied. For instance, if the aerial vehicle's altitude (z) is known from a barometer sensor, a constrained model could be used where only the remaining five parameters are allowed to vary. In the configuration where the sensor data consists of images, the pose can be computed as the well-known Perspective-n-Point (PnP) problem, given the known correspondences between the points (x, y, z) in the vehicle point cloud and image coordinates (row, column). These correspondences are known as the vehicle point cloud is computed from matching of the overlapping images as part of the processing onboard the vehicle.

The above described embodiment discloses a method of how the aerial vehicle's pose could be determined by comparing point clouds. The determined pose is relevant information for various purposes. For instance, the determined pose may be used for the aerial vehicle's own navigation, or be sent to other aerial vehicles or aviation agents for guidance or awareness of the aerial vehicle.

In another related embodiment, that is based on the above disclosed one, in a final action 210, the aerial vehicle uses the determined vehicle pose to adapt or set any of its vehicle parameters, e.g. speed or vehicle angle, like roll, pitch or yaw. Thereby, a reliable navigation could be achieved also when the aerial vehicle is in a GNSS-denied environment.

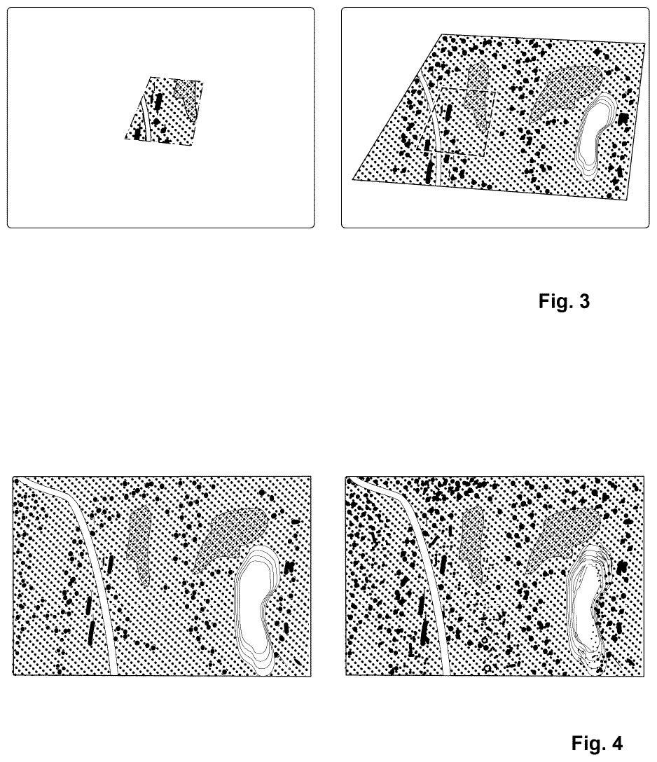

With reference to FIG. 3, which comprises two schematic illustrations, two point clouds will now be described in accordance with one exemplifying embodiment.

In the left view a vehicle point cloud of a 3D environment is illustrated, and the right view a reference point cloud is illustrated.

As described above in conjunction with other embodiments, the vehicle point cloud has been determined by the aerial vehicle based on sensor data acquired with an instrument onboard of the aerial vehicle, e.g. from stereo-matched images acquired by the aerial vehicle, or measurements from an active instrument. The reference point cloud has instead been obtained from some suitable source.

A dashed rectangle in the right view illustrates the environment where the point clouds overlap. The point clouds are compared as described above and common 3D features related to vegetation structures are identified. In the figure, e.g., individual trees are illustrated as dots.

Methods for aerial localization exploiting geometric structure based on matching of height images exists in the literature. Such height images are regularly spaced rasters where pixel values represent height, whereby the height images may be generated by rasterizing point cloud data. The proposed method herein exploits the point cloud data directly, without rasterization. A motivation for exploiting point cloud data rather than height images is that the rasterization process reduces geometric detail, both by converting the irregularly spaced point cloud to regularly spaced rasters and through aggregation of multiple 3D point measurements into a single height value.

FIG. 4, which comprises two schematic illustrations of the same environment but in two different seasons, is used to describe the benefit of using geometric structure of vegetation as basis for vision-based navigation in accordance with one exemplifying embodiment.

The schematics represent the same environment but in different seasons at northern latitudes. The left view illustrates winter conditions, and the right view illustrates summer conditions. Summer conditions represents the environment with the vegetation in its green state, with foliated tree canopies. The winter conditions look significantly different due to snow cover as well as bare tree canopies. In this embodiment, a reference point cloud is generated from images acquired during the winter (left illustration), while the vehicle is flying during the summer (right illustration).

It is hypothesized that with respect to seasonal variations in vegetation (in particular deciduous vegetation), geometric 3D structures are often more persistent than color and texture. Therefore, despite the large seasonal differences on the ground, the proposed solution is expected to successfully determine the vehicle's pose, as it exploits geometric 3D structures of ground objects rather than the ground objects' color and texture. Vision-based navigation that rely on color and texture will likely fail in this scenario.

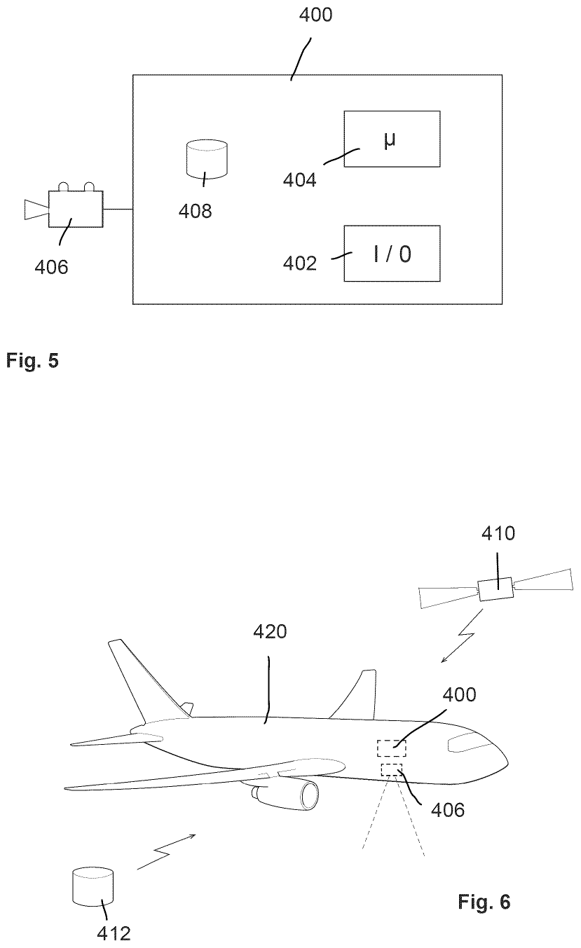

With reference to FIG. 5, which is a schematic illustration, a pose determination module will now be described in accordance with one exemplifying embodiment.

The pose determination module 400 comprises a communication unit 402, a processing unit 404, and optionally a memory unit 408. The communication unit 402 is configured for receiving appropriate signals from sensors and data from databases, e.g., measured signals from inclination sensors and barometers, and reference data from databases. Furthermore, the communication unit 402 may send appropriate signals and data internally to the aerial vehicle. The processing unit 404 is configured to process signals and data to determine the aerial vehicle's pose. The communication unit 402, marked I/O (Input/Output) may be implemented as any suitable communication circuitry. The processing unit 404, marked μ, may instead be implemented as any suitable processing circuitry. In the figure is also a sensor 406 shown that acquires sensor data. The optional memory unit 408 is typically implemented as any appropriate memory circuitry and may store obtained reference point clouds when received. The memory unit 408 may further assist the communication unit 402 and the processing unit 404 with memory capacity when processing and determining the pose. Typically, the memory unit 408 may store the latest determined poses. The pose determination module 400 is configured to determine aerial vehicles' poses in accordance with the methods defined in above-described embodiments.

With reference to FIG. 6, which is a schematic illustration, an aerial vehicle will now be described in accordance with one exemplifying embodiment.

The aerial vehicle 420 is here illustrated as a conventional airplane. However, the disclosed concept may be implemented in any suitable type of aerial vehicles, like UAVs, helicopters, etc., without being limited to any specific type of aerial vehicle.

The airplane 420 is equipped with a pose determination module 400 and an instrument for acquiring sensor data related to vegetational structures. When in service, the airplane 420 receives GNSS-signals from a satellite 410. However, in case that the airplane 420 is not capable of receiving signals therefrom, the airplane will instead apply the methods for determining pose that are described above in other embodiments.

The airplane 420 makes than use of its arranged pose determination module 400 for obtaining a reference point cloud and its instrument for acquiring sensor data related to vegetation structures and is then enabled to proceed flying reliably and securely. The airplane 420 may of course determine poses with the proposed method also when navigating based on GNSS-signals, as complement and for improved accuracy.

Reference throughout the specification to “one embodiment” or “an embodiment” is used to mean that a particular feature, structure or characteristic described in connection with an embodiment is included in at least one embodiment.

Thus, the appearance of the expressions “in one embodiment” or “in an embodiment” in various places throughout the specification are not necessarily referring to the same embodiment. Further, the particular features, structures or characteristics may be combined in any suitable manner in one or several embodiments. Although the present invention has been described above with reference to specific embodiments, it is not intended to be limited to the specific form set forth herein. Rather, the invention is limited only by the accompanying claims and other embodiments than the specific above are equally possible within the scope of the appended claims. Moreover, it should be appreciated that the terms “comprise/comprises” or “include/includes”, as used herein, do not exclude the presence of other elements or steps.

Furthermore, although individual features may be included in different claims, these may possibly advantageously be combined, and the inclusion of different claims does not imply that a combination of features is not feasible and/or advantageous. In addition, singular
references do not exclude a plurality. Finally, reference signs in the claims are provided merely as a clarifying example and should not be construed as limiting the scope of the claims in any way.

The scope is generally defined by the following independent claims. Exemplifying embodiments are defined by the dependent claims.

1. Method of determining a pose of an aerial vehicle, the pose being related to at least one of the aerial vehicle's location and the aerial vehicle's orientation comprising:
obtaining a reference point cloud,
determining a vehicle point cloud representing geometric shape or geometric distribution of individual vegetation objects, or of groups of vegetation objects of the environment related to the position of the aerial vehicle,
comparing the vehicle point cloud with the reference point cloud to generate a mathematical transformation therebetween, wherein comparing the vehicle point cloud with the reference point cloud comprises calculating the mathematical transform that aligns the vehicle point cloud with the reference point cloud, based on identified point correspondences, the point correspondences were identified based on:
comparison of 3D features in the vehicle point cloud and the reference point cloud, or
direct comparison between the vehicle point cloud and the reference point cloud, and
determining the pose of the aerial vehicle based on the mathematical transformation.

2. The method according to claim 1, wherein determining the pose comprises determination of at least one parameter of the aerial vehicle from a set of: x-coordinate, y-coordinate, z-coordinate, roll (φ), pitch (θ) and yaw (ψ), the pose being defined by at least one of the determined parameters.

3. The method according to claim 1, wherein determining the vehicle point cloud comprises acquiring sensor data by means of an instrument arranged at the aerial vehicle, the instrument being any of:
a passive instrument, preferably an image capturing device, and
an active instrument, preferably a laser scanner.

4. The method according to claim 3, wherein the instrument is a passive instrument implemented as a camera and the sensor data comprises two overlapping images, wherein determining the vehicle point cloud comprises matching the images, and wherein the respective images are:
consecutive images, acquired with the camera during motion of the aerial vehicle, or
simultaneous images acquired with the camera and a further camera arranged at the aerial vehicle.

5. The method according to claim 3, wherein the instrument is an active instrument, preferably a laser scanner, wherein determining the vehicle point cloud comprises processing of the captured sensor data.

6. The method according to claim 1, wherein obtaining the reference point cloud comprises one or more of:
obtaining the reference point cloud in advance from an external source; and
obtaining further reference points during travel of the aerial vehicle.

7. A method of navigating an aerial vehicle, comprising:
determining the geographic location according to claim 1, and
controlling a vehicle parameter based on the determined location of the aerial vehicle, the vehicle parameter being at least one of: vehicle speed, and vehicle angle, preferably, roll (φ), pitch (θ) and heading (ψ).

8. A pose determination module for determining a pose of an aerial vehicle, comprising:
a communication unit configured to obtain a reference point cloud,
a determination unit, configured to:
determine a vehicle point cloud representing geometric shape or geometric distribution of individual vegetation objects, or of groups of vegetation objects of the environment related to the position of the aerial vehicle,
compare the vehicle point cloud with the reference point cloud to generate a mathematical transformation therebetween, and
determine the pose of the aerial vehicle based on the mathematical transformation,
wherein the determination unit is configured to compare the vehicle point cloud with the reference point cloud by: calculating a mathematical transform that aligns the vehicle point cloud and the reference point cloud, based on identified point correspondences, the point correspondences being identified based on:
comparison of 3D features in the vehicle point cloud and the reference point cloud, or
direct comparison between the vehicle point cloud and the reference point cloud.

9. The pose determination module according to claim 8, wherein the determination unit is configured to the determine the pose by determining at least one parameter of the aerial vehicle from a set of: x-coordinate, y-coordinate, z-coordinate, roll (φ), pitch (θ) and yaw (ψ), the pose being defined by at least one of the determined parameters.

10. The pose determination module according to claim 8, wherein the determination unit is configured to determine the vehicle point cloud by acquiring sensor data by means of an instrument arranged at the aerial vehicle, the instrument being any of:
a passive instrument, preferably an image capturing device, and
an active instrument, preferably a laser scanner or a radar.

11. The pose determination module according to claim 10, wherein the instrument is a passive instrument implemented as a camera and the sensor data comprises two overlapping images, where the determination unit is configured to determine the vehicle point cloud by matching the two images as:
consecutive images, acquired with the camera during motion of the aerial vehicle, or
simultaneous images acquired with the camera and a further camera arranged at the aerial vehicle.

12. The pose determination module, according to claim 10, wherein the instrument is an active instrument, preferably a laser scanner, wherein the determination unit is configured to determine the vehicle point cloud by processing the acquired sensor data.

13. The pose determination module according to claim 8, wherein the communication unit is configured to obtain the reference point by performing at least one of:
obtaining the reference point cloud in advance from an external source; and
obtaining further reference points during travel of the aerial vehicle.

14. An aerial vehicle comprising:
an instrument configured to acquire sensor data, and
the pose determination module according to claim 8, configured to determine the aerial vehicle's pose based on the acquired sensor data.

15. A computer program comprising instructions, which when executed by processing circuitry cause the processing circuitry to perform the method according to claim 1.

16. A computer-program product comprising a non-volatile computer readable storage medium having stored thereon, the computer program according to claim 15.
